(19) United States
(12) Patent Application Publication
(10) Pub. No.: US 2005/0237015 A1
(43) Pub. Date: Oct. 27, 2005

(54) Method and apparatus using movable barrier zones

(75) Inventors: James J. Fitzgibbon, Batavia, IL (US); Robert Keller, Chicago, IL (US); Colin Willmott, Buffalo Grove, IL (US); William Gioia, Winfield, IL (US); Richard Hill, McHenry, IL (US); David Schuda, Wheaton, IL (US); Davide Alborghetti, Lombardo (IT)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/832,807

(22) Filed: Apr. 27, 2004

(51) Int. Cl. H02P 3/00; H02P 1/00

(52) U.S. Cl. 318/280; 318/466

(57) ABSTRACT

Multiple zones (21, 22, 23) are established with respect to the travel of a movable barrier over a course of permitted movement (typically between a fully open and a fully closed position). By detecting and knowing the juxtaposition of the movable barrier with a given one of these zones, a particular direction of movement for that movable barrier can be automatically selected notwithstanding possible ignorance regarding the exact position of the movable barrier due to, for example, one or more triggering conditions (such as momentary disconnection of the movable barrier with respect to its motive mechanism). Such zones are particularly efficacious when employed in conjunction with passpoint-based position determination movable barrier operator systems.

### FIELD OF THE INVENTION

This invention relates generally to movable barrier operators as are used to facilitate selective movement of a movable barrier.

### BACKGROUND OF THE INVENTION

Movable barrier operators of various kinds are known in the art. In general, such operators serve to effect selective movement of a movable barrier (including but not limited to garage doors of various kinds, rolling shutters, and other horizontally or vertically sliding, moving, or pivoting doors, gates, arms, and the like) between at least a first position and a second position (such as between an opened and a closed position). In many cases it can be important to know with some specificity the location of those first and second positions with respect to a present position of the movable barrier itself. Such location information can serve a variety of purposes that benefit the proper and uneventful movement of the movable barrier.

One prior art solution uses one or more switches to identify specific the open and closed positions as correspond to the travel of a movable barrier. Such a switch (which is often located in a position that will prompt interaction between the movable barrier and the switch when the movable barrier arrives at a given location) will typically source a signal to denote when the movable barrier occupies a specific point during its travel. Though useful for many purposes, such switches are prone to various difficulties. In particular, such switches often require fairly precise positioning. This, in turn, can require time, attention, tools, and training that may not be readily available in all installation settings. Further, such embodiments are prone to becoming uncalibrated over time due to aging, temperature cycling, physical contact, and other incidents that can and will alter the relative position of the switch with respect to the movable barrier.

Passpoint-based systems comprise a more recent approach to ascertaining the present position of a movable barrier. A switch or other mechanism produces a discernable passpoint event (such as a voltage or current pulse) whenever the movable barrier first passes a particular point of travel (typically a point disposed somewhere between the terminus points of permissible travel for the movable barrier). Another mechanism (such as an optical or magnetic-based sensor system) provides a series of signals that correspond to small incremental equal amounts of movement for the movable barrier.

In a typical embodiment a movable barrier operator counts the number of such pulses as occur while moving in a given direction from the passpoint event in a particular direction of movement during a training mode of operation to a specific position (such as a fully-opened or closed position). The operator then uses that count result during subsequent operations to determine when that corresponding specific position is nearing and/or is reached.

Such passpoint-based position determination systems are highly effective in many applications. There are circumstances or settings, however, when its application may be less than optimum (at least as perceived by a consumer). For example, a power outage can occur during movement of the movable barrier. Such an event will typically halt movement of the movable barrier. A person seeking to effect movement of the movable barrier may then employ a mechanical disconnect mechanism to disconnect the movable barrier from the movable barrier operator drive system to thereby effect non-automated movement of the movable barrier to a desired position. When this occurs, the movable barrier may be reconnected to the drive system at a new position. This, in turn, can lead to error regarding a present passpoint-based count as maintained by the movable barrier operator. Upon reapplication of power, the movable barrier operator may cause undesired movement (or stoppage) of the movable barrier based upon this incorrect position information.

### BRIEF DESCRIPTION OF THE DRAWINGS

The above needs are at least partially addressed through provision of the method and apparatus using movable barrier zones described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a schematic view of movable barrier travel as configured in accordance with various embodiments of the invention;

FIG. 4 comprises a schematic view of movable barrier travel as configured in accordance with various embodiments of the invention;

FIG. 5 comprises a detail view as configured in accordance with various embodiments of the invention;

FIG. 6 comprises a graph as configured in accordance with various embodiments of the invention;

FIG. 7 comprises two graphs as configured in accordance with various embodiments of the invention;

FIG. 8 comprises a flow diagram as configured in accordance with various embodiments of the invention;

FIG. 9 comprises a schematic view of movable barrier travel as configured in accordance with various embodiments of the invention;

FIG. 10 comprises a schematic view of movable barrier travel as configured in accordance with various embodiments of the invention; and

FIG. 11 comprises a flow diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Generally speaking, pursuant to these various embodiments, at least two zones for corresponding ranges of travel of a movable barrier are established. In a preferred embodiment, at least a second such zone is at least partially different from a first such zone. A movable barrier operator detects when the movable barrier has a predetermined positional relationship with respect to either of these zones to provide a detected zone. Then, upon detecting at least a first predetermined state with respect to the movable barrier operator, the operator automatically selects a particular direction of movement for the movable barrier as a function, at least in part, of the detected zone.

Depending upon the needs of a given application, these zones can comprise, in the aggregate, substantially all of a permitted travel distance for the movable barrier. In a preferred embodiment, the detected predetermined state corresponds to disconnection of the movable barrier from the movable barrier operator (such as can occur when someone disengages the movable barrier from the drive train in order to effect non-automated movement of the movable barrier for whatever reason).

Such a configuration works well with passpoint-based position determination systems. Pursuant to one approach, upon detecting the predetermined state, the movable barrier causes automated movement of the movable barrier in a first direction of movement when presently detecting, for example, a first zone and in a second direction of movement when presently detecting, for example, a second zone. So configured, for example, the movable barrier can be caused to automatically move towards a passpoint position in response to detecting specific trigger criteria. This, in turn, causes the system to effectively become recalibrated with respect to present location of the movable barrier. In particular, by causing the movable barrier to move towards a passpoint position, the movable barrier will engage the passpoint position and the movable barrier operator will again have benefit of this known position indicia.

These teachings are also usefully applied in a multi-passpoint position determination system. More particularly, a synergistic combination of multiple zones and a plurality of passpoint events can be used to not only assure safe and effective operation of the movable barrier following potentially disconcerting events but to also aid in effecting movement of the movable barrier in a manner that tends to accord well with a user's expectations. This, in turn, can aid in instilling comfort in the user as regards operation of the movable barrier operator itself.

Other benefits will become evident to those skilled in the art upon making a thorough review and study of the following detailed description of various illustrative embodiments.

Various movable barrier operators can embody the teachings presented herein. For purposes of presenting an illustrative embodiment, and referring now to FIG. 1, a movable barrier operator 10 can comprise a movable barrier controller 11 that couples to and selectively controls a motor 12 or other motive mechanism to thereby control the operation of a corresponding movable barrier 13. Numerous embodiments of such components are well understood in the art and additional elaboration here will not be presented for the sake of clarity. In general, it is noted that the movable barrier controller 11 will typically comprise, in a preferred approach, a fully or partially programmable platform to thereby facilitate implementation of the described functionality. If desired, however, those skilled in the art will appreciate that a dedicated purpose platform and/or a hard-wired controller could also be appropriately arranged and configured to operate in a similar fashion.

For purposes of this illustrative description, the movable barrier operator 10 also comprises at least a first passpoint sensor 14 that operably couples to the movable barrier controller 11. Such sensors are generally understood in the art and further details regarding at least some alternative sensor embodiments are presented further below. In a preferred approach, this first passpoint sensor 14 has an output that provides a first substantially consistent indicia when the movable barrier 13 is positioned on one side of the passpoint sensor 14 and a second substantially consistent indicia (which second substantially consistent indicia is different from the first substantially consistent indicia) when the movable barrier 13 is positioned on an opposite side of the first passpoint sensor 14. Such substantially consistent indicia represent, in this embodiment, two different zones of travel, with a different zone of travel corresponding to opposite sides of the passpoint event sensor 14.

So configured, the movable barrier controller 11 can have at least a first mode of operation wherein the movable barrier 13 is automatically caused to move in a particular direction as a function, at least in part, of whether the movable barrier 13 is on one side of the first passpoint sensor 14 or on the opposite side thereof. Such a first mode of operation can be triggered, in one embodiment, by detection of a particular state as monitored by, for example, an event sensor 15 (such as, for example, a drive train disconnection sensor that responds to decoupling of the movable barrier 13 from the motor 12). Such direction control functionality can serve to select a particular direction of movement for the movable barrier 13 based upon which side of the first passpoint sensor 14 the movable barrier 13 is presently positioned. More particularly, in one approach, this direction control capability can be used to select a particular direction of movement that causes the movable barrier to moves towards the first passpoint sensor 14. At least some benefits of such an approach are discussed in more detail below.

In the above-described embodiment, the movable barrier operator 10 has a single passpoint event sensor 14. It would of course be possible to employ such zones in an embodiment that does not employ any passpoint sensors. It would also be possible to extend these teachings to embrace an embodiment having two or more passpoint sensors. For example, when two such passpoint sensors are employed, the second passpoint sensor can have an output that provides a third substantially consistent indicia when a movable barrier is positioned on one side of the second passpoint sensor and a fourth substantially consistent indicia (which fourth indicia is different from the third indicia) when a movable barrier is positioned on an opposite side of the second passpoint sensor. So configured, the movable barrier controller 11 can base direction-of-movement determinations upon the present position of the movable barrier 13 with respect to both the first passpoint sensor and the second passpoint sensor. Again, additional details regarding the operation and benefits of such a configuration are presented further below.

As noted earlier, the just-described platform embodiments are suitable to support the processes described herein. It will be understood by those skilled in the art, however, that other platforms may work as well or better depending upon the needs and requirements of a given setting and context.

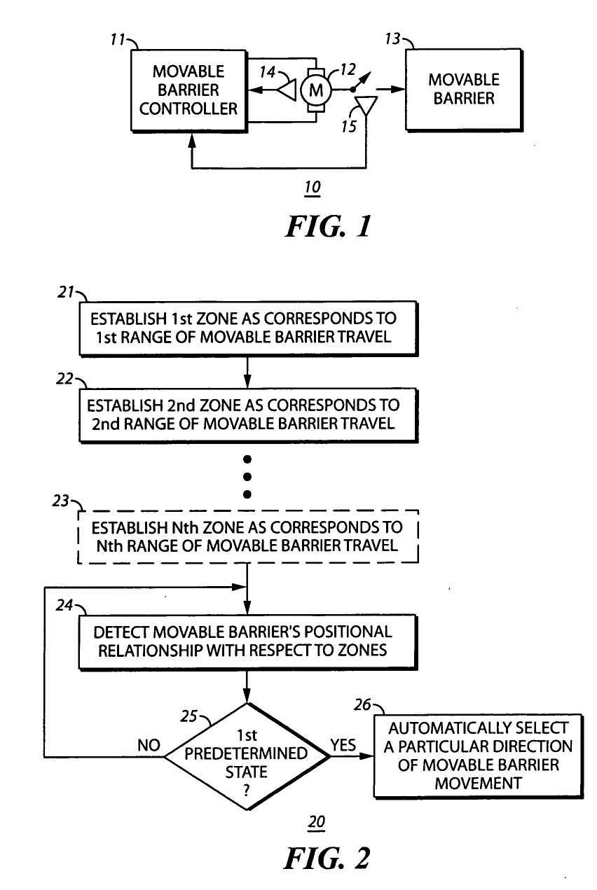

Referring now to FIG. 2, an overall exemplary process 20 provides for establishment 21 of a first zone as corresponds to a first range of travel of a movable barrier and for establishment 22 of a second zone as corresponds to a second range of travel of the movable barrier (which second zone is at least partially different than the first zone).

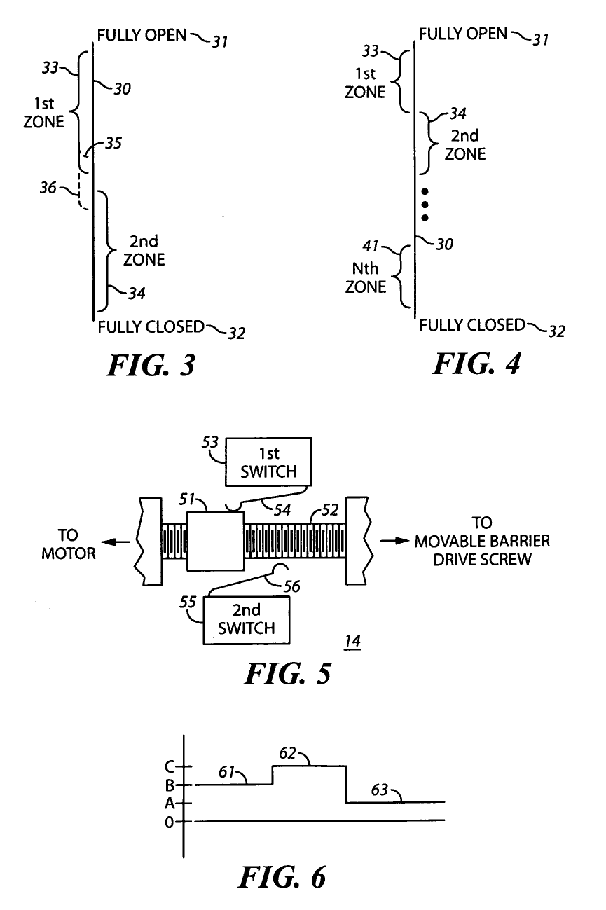

For example, and referring momentarily to FIG. 3, the complete range of travel 30 for a given movable barrier will typical bridge the distance between a fully open position 31 and a fully closed position 32. The first zone 33 and the second zone 34 can each be fully discrete from one another as shown such that there is no overlap between these two zones. The zones 33 and 34 can be sized to together comprise in the aggregate substantially all of the permitted travel distance of the movable barrier. Or, if desired (and as illustrated), these zones 33 and 34 can be sized so that portions of the permitted travel distance do not comprise a part of any zone. Also, although the zones 33 and 34 can be of a similar size, other proportional apportionment can be imposed as appropriate. For example, the first zone 33 could be reduced in size (as represented by reference numeral 35) or increased in size (as represented by reference numeral 36) to suit specific requirements as needed.

Referring again to FIG. 2, this process 20 can provide for the establishment 23 of additional zones that each correspond to additional ranges of travel of the movable barrier and where each such additional zone is preferably at least partially different than the other zones. For example, and referring momentarily to FIG. 4, the complete range of travel 30 can be sub-divided into a first zone 33, a second zone 34, and up to N other zones 41 (where N simply refers to any desired number of zones as may suit the needs of a given application). Again, such zones can together equal the complete permitted range of travel 30 or can equal some lesser distance. And also again, such zones can partially overlap with one another or can be discrete from one another.

In general, for many applications, it is preferred that there be one zone that is positioned to correspond to a range of travel that is proximal to the fully-opened position 31 of the movable barrier and another zone that is positioned to correspond to a range of travel that is proximal to the fully-closed position 32 of the movable barrier. It is also preferred for many applications that these zones essentially abut one another, such that they neither overlap one another to any significant degree nor that there exist any significant non-zone gaps between such zones.

Referring again to FIG. 2, the process 20 then detects 24 when the movable barrier has a predetermined positional relationship with respect to any of the so-established zones to provide a corresponding detected zone. This can comprise (as will be related below in more detail), for example, detection of characterizing voltage levels as correlate to various of the zones. The process 20 then monitors for the occurrence of at least a first predetermined state 25 with respect to the movable barrier operator (including the movable barrier itself, the drive train, and/or the movable barrier controller) (for example, the monitored predetermined state can comprise disconnection of the movable barrier from the movable barrier operator).

Upon detecting the first predetermined state (either for at least a predetermined period of time or as an instantaneous trigger) the process 20 then provides for automatic selection 26 of a particular direction of movement for the movable barrier as a function, at least in part, of the detected zone. For example, the process 20 can provide for automatic selection of a first direction of movement for the movable barrier when presently detecting the first zone and selection of a second, different direction of movement for the movable barrier when presently detecting the second zone. The first direction can comprise, for example, an opening direction of movement and the second direction can similarly comprise a closing direction of movement (or vice versa). Other possibilities also exist. For example, pursuant to one embodiment, the process 20 can automatically select a direction of movement that is the same as, or different than, a presently-selected direction of movement. That is, the process 20 can use the detected zone information to determine whether to continue to apply a presently-selected direction of movement (that is, the direction of movement as was presently-selected at the time of detecting the predetermined state) or to apply a different direction of movement (such as an opposite direction of movement).

This zone-based direction-selection capability can be employed in various ways to facilitate various desired movable barrier operations. For example, such zones can be usefully employed with some passpoint-based position determination systems (particularly, though not exclusively, with swinging gates and jackshaft-based movable barrier systems).

Such zones can be demarked in any of a wide variety of ways. For example, independent switches and switch-sensitive surfaces/signal generators can be deployed along the movable barrier travel path to provide associated zone indicia. Pursuant to one embodiment, zone demarkation indicia is usefully combined with passpoint event generation. In such an integrated mechanism, the passpoint event does not necessarily comprise a discrete signal pulse (such as a voltage or current spike). Instead, the passpoint event can comprise a transition between varying levels of substantially consistent indicia that each serve to identify a given zone of travel.

For example, and referring now to FIG. 5, a traveling member 51 having a threaded interior is threadably engaged about a finely threaded member 52 that couples to (or itself comprises) a movable barrier drive screw. So configured, the finely threaded member 52 rotates in response to the movable barrier operator motor and in turn transfers that rotation via the movable barrier drive screw to a transfer mechanism that causes the desired movement of the movable barrier. When this finely threaded member 52 rotates in a first direction the movable barrier moves in a first direction (such as towards a fully opened position) and when this member 52 rotates in a second opposite direction the movable barrier moves in a second opposite direction (such as towards a fully closed position).

In this embodiment, the traveling member 51 moves back and forth along the length of the finely threaded member 52 in response to such rotation (by prohibiting rotation of the traveling member 51 itself). The relative position of this traveling member 51 is sensed by one or both of two switches 53 and 55. In the illustration provided, the sensing arm 54 of a first switch 53 interacts with the traveling member 51 while the sensing arm 56 of the second switch 55 does not. Each switch will provide a corresponding signal output to indicate these relative states of contact. As the traveling member 51 moves to the right (in this illustration), the traveling member 51 will eventually engage the sensing arms of both switches. And, if and as the traveling member 51 continues this direction of travel, the traveling member 51 will eventually lose contact with the first switch 53 and will only engage the second switch 55.

These contact states can be signaled and/or detected in various ways. Pursuant to one approach, and referring now to FIG. 6, the first switch 53, when asserted, creates a voltage B. The second switch 55, when asserted, creates a voltage A. So configured, a first zone 61 can be associated with a first voltage B that occurs when only the first switch 53 is asserted. A second zone 62 can correspond to a voltage C which is created when both switches 53 and 55 are asserted. And lastly, a third zone 63 can correspond to voltage A as occurs when only the second switch 55 is asserted. By monitoring such voltage levels, a movable barrier controller can readily ascertain at essentially any given time which of these three zones is presently in evidence.

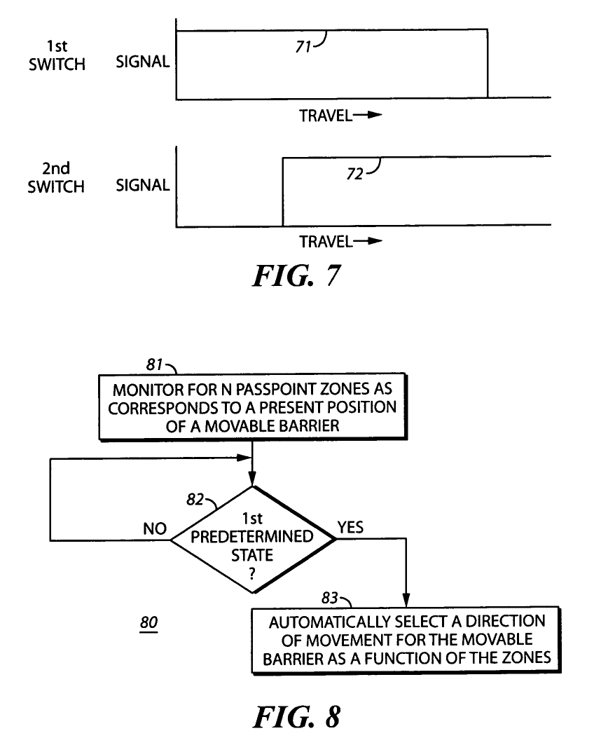

Pursuant to another approach, and referring now to FIG. 7, the signals as output by each switch can be monitored in discrete rather than summed fashion. For example, the first switch signal 71 can be monitored and its presence or absence compared against the presence or absence of the second switch signal 72. Taking this approach, a presence of the first switch signal 71 coupled with an absence of the second switch signal 72 indicates the first zone of travel. Presence of the first switch signal 71 coupled with presence of the second switch signal 72 indicates the second zone of travel. And absence of the first switch signal 71 coupled with presence of the second switch signal 72 indicates the third zone of travel. Again, by monitoring such signals, a movable barrier controller can readily determine which zone is presently evident.

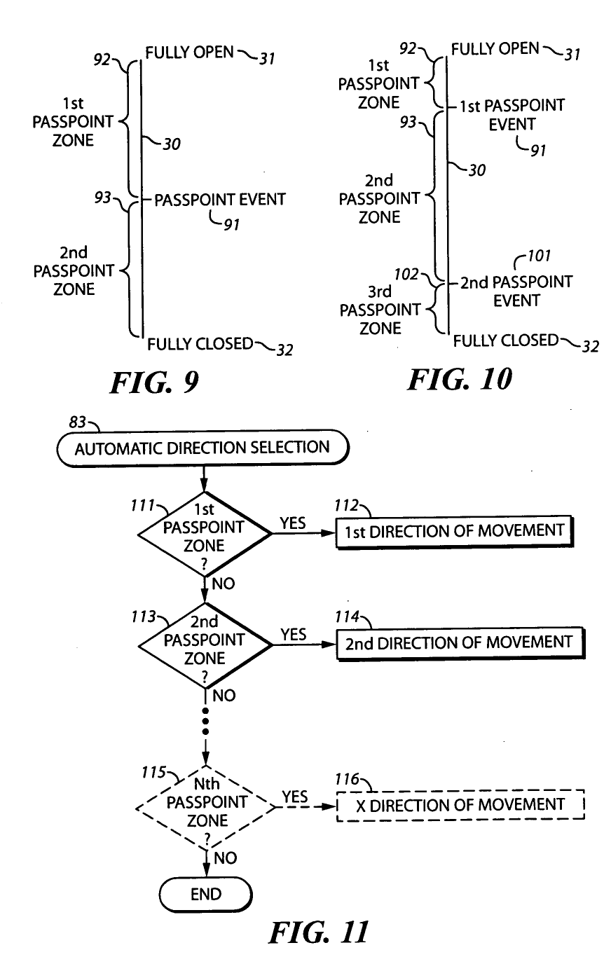

Referring now to FIG. 8, a corresponding process 80 can monitor 81 for at least a first and a second passpoint zone as correspond to a present position of a movable barrier. As noted above, these passpoint zones can together comprise substantially all of a permitted travel distance of the movable barrier (or not, depending upon the needs of the application). With momentary reference to FIG. 9, when only two passpoint zones are provided, a first passpoint zone 92 can represent a range of travel that extends between a given passpoint event 91 and the fully open position 31. A second passpoint zone 93 can then represent the range of travel that extends between that passpoint event 91 and the fully closed position 32. (As noted above, such zones do not necessarily need to discretely represent the total potential travel distance of the movable barrier, but in a preferred approach will.) In such an embodiment the passpoint event 91 will preferably comprise a discernable transition between the passpoint zones rather than a discrete pulse or notch.

Referring again to FIG. 8, the process 80 then again monitors to detect 82 the occurrence of a first predetermined state (such as, but not limited to, an event that may lead to un-calibration of the passpoint-based position determining system). When this predetermined state occurs, the process 80 then automatically selects a particular direction of movement for the movable barrier as a function, at least in part, of the first passpoint zone and the second passpoint zone. As one example, when the process 80 detects the first passpoint zone, the movable barrier can be caused to automatically move towards the fully closed position 32. Similarly, when the process 80 detects the second passpoint zone, the movable barrier can be caused to automatically move towards the fully open position 31.

Though the movable barrier controller will be generally unaware under such circumstances of exactly where the movable barrier is with respect to its full travel distance, by knowing which zone is presently occupied by the movable barrier, the direction selections will cause movement of the movable barrier towards the passpoint event 91. Upon encountering the passpoint event 91, of course, the movable barrier controller will again be fully calibrated and will know exactly where the movable barrier is with respect to its full range of travel.

So configured, a movable barrier may be moving towards a closed position when power is lost. Upon regaining power, and upon detecting, for example, that the movable barrier is in the second passpoint zone 93, the movable barrier can be automatically caused to move opposite its original direction of movement. This, in turn, causes the movable barrier to subsequently encounter the passpoint and thereby recalibrate the system as to the position of the movable barrier. If desired, at this point, the direction of the movable barrier could again be reversed to cause the movable barrier to move again in the original direction of movement. This time, however, the movable barrier controller will know the present position of the movable barrier and can assure that the movable barrier will be stopped at the appropriate point during travel upon reaching the fully closed position 32.

As noted before, there may be more than two zones defined for a given movable barrier. This, in turn, can well suit the use of more than one passpoint. For example, and referring now to FIG. 10, a given movable barrier operator system may employ two passpoint events 91 and 101, with a first passpoint event 91 being located proximal to (but preferably not coincident with) the fully opened position 31 and the second passpoint event 101 being located proximal to (but preferably not coincident with) the fully closed position 32. Using techniques such as those disclosed above, or any other enabling approach, a first passpoint zone 92 defines a range of travel as between the fully opened position 31 and the first passpoint event 91, a second passpoint zone 93 defines a range of travel as between the first passpoint event 91 and the second passpoint event 101, and a third passpoint zone 102 defines a range of travel as between the second passpoint event 101 and the fully closed position 32.

So arranged, a movable barrier controller can readily ascertain at any given moment whether the movable barrier is presently somewhere between the fully open position 31 and the first passpoint event 91 (i.e., in the first passpoint zone 92), somewhere between the two passpoints 91 and 101 (i.e., in the second passpoint zone 93), or somewhere between the second passpoint 101 and the fully closed position 32 (i.e., in the third passpoint zone 102).

When the movable barrier controller detects a triggering state (such as disconnection of the movable barrier from the motive mechanism) and then subsequently operates to automatically select a direction of movement for the movable barrier, these three zones can be usefully employed to inform that selection process. For example, and referring now to FIG. 11, when the selection process 83 determines 111 that the movable barrier is in the first passpoint zone as exemplified above, a corresponding first direction of movement is selected 112. In a preferred approach, this direction of movement is towards the first passpoint event 91 and away from the fully opened position 31. So configured, the movable barrier will avoid an inappropriate incident caused by attempting to reach the fully closed position 31 without accurate information regarding the present position of the movable barrier with respect to that fully closed position. Once the first passpoint event 91 has been reached, of course, the movable barrier controller will be recalibrated with respect to the present position of the movable barrier. Therefore, if desired, the movement of the movable barrier operator can be changed, if necessary, to match the movable barrier's direction of movement at the time of sensing the triggering event (i.e., the predetermined state).

If the movable barrier is not within the first passpoint zone but is within the second passpoint zone, the movable barrier controller again can detect 113 this state and effect selection 114 of a second corresponding direction of movement. In this particular illustrative example, the second passpoint zone corresponds to a zone that is bracketed on either side by a passpoint event. Furthermore, the movable barrier cannot be moved beyond the second zone without passing a passpoint event and hence cannot approach the fully open or fully closed position without also being recalibrated with respect to present position of the movable barrier. So configured, in a preferred embodiment, the movable barrier controller can automatically select a direction of movement that is the same as a direction of movement for the movable barrier at the time of experiencing the triggering event. Other alternatives are of course possible. For example, the direction of movement could be reversed from the present direction of movement as of the time of experiencing the monitored state if so desired.

When the movable barrier controller determines 115 instead that the movable barrier is in, for example, the third zone as configured in the above example, a corresponding direction of movement can again be selected 116. Again presuming the three-zone/two-passpoint event configuration described above, in a preferred approach this second corresponding direction of movement is towards the second passpoint event 101 and away from the fully closed position 32. Therefore, again, if the movable barrier operator system experiences the triggering event of concern, upon recovery, the movable barrier controller will detect the present position of the movable barrier and automatically select movement away from the closed position 32 and towards the passpoint event 101 that will permit recalibration regarding the present position of the movable barrier.

Those skilled in the art will appreciate that such zones as correspond to particular ranges of travel have various uses and that such zones are particularly helpful when used in conjunction with passpoint-based position determination systems. By characterizing either side of one or more passpoint events with ongoing passpoint indicia that identifies corresponding zones of travel, present location of a movable barrier within a given zone of travel can be reliably ascertained even though a precise position of the movable barrier remains unknown. This information can then be leveraged to facilitate automatic selection of a particular direction of travel for that movable barrier upon the occurrence of one or more predetermined events. By appropriate location and sizing of such zones (for example, with respect to placing relatively small zones in proximity to the fully closed and fully opened positions), in general, only relatively short distances will need to be traversed in a possibly backwards direction of movement (as viewed from the perspective of an onlooker) in order to reestablish the known position of the movable barrier.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method comprising:
monitoring for at least a first passpoint zone and a second, different passpoint zone as corresponds to a present position of a movable barrier;
upon detecting at least a first predetermined state with respect to a movable barrier operator, automatically selecting a particular direction of movement for the movable barrier as a function, at least in part, of the first passpoint zone and the second passpoint zone.

2. The method of claim 1 wherein the first passpoint zone and the second passpoint zone together comprise substantially all of a permitted travel distance of the movable barrier.

3. The method of claim 1 wherein monitoring for at least a first passpoint zone comprises monitoring for a particular electric signal.

4. The method of claim 3 wherein monitoring for a particular electric signal further comprises monitoring for a particular range of voltage.

5. The method of claim 1 wherein detecting at least a first predetermined state further comprises detecting disconnection of the movable barrier from the movable barrier operator.

6. The method of claim 1 wherein automatically selecting a particular direction of movement for the movable barrier as a function, at least in part, of the first passpoint zone and the second passpoint zone further comprises:
selecting a first direction of movement for the movable barrier when presently detecting the first passpoint zone; and
selecting a second direction of movement for the movable barrier, which second direction of movement is different from the first direction of movement, when presently detecting the second passpoint zone.

7. The method of claim 6 wherein:
selecting a first direction of movement further comprises selecting an opening direction of movement; and
selecting a second direction of movement further comprises selecting a closing direction of movement.

8. The method of claim 6 wherein:
selecting a first direction of movement further comprises selecting a direction of movement that is towards a passpoint; and
selecting a second direction of movement further comprises selecting a direction of movement that is towards the passpoint.

9. The method of claim 1 wherein monitoring for at least a first passpoint zone and a second, different passpoint zone as corresponds to a present position of a movable barrier further comprises monitoring for at least a first passpoint zone as corresponds to a present position of the movable barrier, a second passpoint zone as corresponds to a present position of the movable barrier, and a third passpoint zone as corresponds to a present position of the movable barrier, wherein the first, second, and third passpoint zones are substantially discrete from one another.

10. The method of claim 9 wherein the first passpoint zone corresponds to at least a fully-opened position of the movable barrier.

11. The method of claim 10 wherein the third passpoint zone corresponds to at least a fully-closed position of the movable barrier.

12. The method of claim 9 wherein automatically selecting a particular direction of movement for the movable barrier as a function, at least in part, of the first passpoint zone and the second passpoint zone further comprises selecting a particular direction of movement for the movable barrier as a function, at least in part, of the first passpoint zone, the second passpoint zone, and the third passpoint zone.

13. The method of claim 12 wherein selecting a particular direction of movement for the movable barrier as a function, at least in part, of the first passpoint zone, the second passpoint zone, and the third passpoint zone further comprises:
selecting a first direction of movement for the movable barrier when presently detecting the first passpoint zone; and
selecting a second direction of movement for the movable barrier, which second direction of movement is different from the first direction of movement, when presently detecting the third passpoint zone.

14. The method of claim 13 wherein selecting a particular direction of movement for the movable barrier as a function, at least in part, of the first passpoint zone, the second passpoint zone, and the third passpoint zone further comprises:
selecting a presently-selected direction of movement for the movable barrier when presently detecting the second passpoint zone.

15. The method of claim 14 wherein selecting a presently-selected direction of movement further comprises selecting a direction of movement as was then presently selected upon detecting the first predetermined state.

16. The method of claim 15 wherein:
selecting a first direction of movement further comprises selecting an opening direction of movement; and
selecting a second direction of movement further comprises selecting a closing direction of movement.

17. The method of claim 14 and further comprising:
determining that at least one of the first and third passpoint zones will not likely be detected during normal movement of the movable barrier.

18. The method of claim 17 and further comprising:
in response to determining that at least one of the first and third passpoint zones will not likely be detected during normal movement of the movable barrier, selecting a direction of movement for the movable barrier that is towards a passpoint when presently detecting the second passpoint zone.

19. A method for use with a movable barrier operator that effects controlled movement of a movable barrier between at least a first position and a second position, comprising:
providing at least one passpoint event to occur during movement of the movable barrier between the first position and the second position, which passpoint event is characterized by ongoing passpoint indicia that identifies at least a first zone of travel on a first side of the passpoint event and a second zone of travel on a second side of the passpoint event;
using the passpoint event as a reference point for maintaining a count as corresponds to a position of the movable barrier;
using the count to determine, at least in part, a position of the movable barrier with respect to the first position and the second position;
upon detecting at least a predetermined event, selecting a particular direction of travel for the movable barrier as a function, at least in part, of the passpoint indicia.

20. The method of claim 19 wherein providing at least one passpoint event further comprises providing at least two passpoint events to occur during movement of the movable barrier between the first position and the second position.

21. The method of claim 20 wherein providing at least two passpoint events further comprises providing a first passpoint event to occur when the movable barrier is at least proximal to the first position.

22. The method of claim 21 wherein providing at least two passpoint events further comprises providing a second passpoint event to occur when the movable barrier is at least proximal to the second position.

23. The method of claim 20 wherein:
a first passpoint event is characterized by first ongoing passpoint indicia on one side of the first passpoint event and second ongoing passpoint indicia on an opposite side of the first passpoint event;
a second passpoint event is characterized by the second ongoing passpoint indicia on one side of the second passpoint event and third ongoing passpoint indicia on an opposite side of the second passpoint event.

24. The method of claim 23 wherein selecting a particular direction of travel for the movable barrier as a function, at least in part, of the passpoint indicia further comprises:
selecting a direction of travel that is away from both the first and second passpoint events when a present position of the movable barrier corresponds to either of the first and third ongoing passpoint indicia;
selecting an unchanged direction of travel when a present position of the movable barrier corresponds to the second ongoing passpoint indicia.

25. A method for use with a movable barrier operator that effects controlled movement of a movable barrier between at least a first position and a second position, comprising:
providing at least one passpoint event to occur during movement of the movable barrier during movement between the first position and the second position;
providing first zone indicia to indicate when the movable barrier is presently positioned within a first zone of travel;
providing second zone indicia to indicate when the movable barrier is presently positioned within a second zone of travel;
in response to detecting at least a predetermined event, selecting a particular direction of travel as a function, at least in part, of the first zone indicia and the second zone indicia.

26. The method of claim 25 wherein providing at least one passpoint event further comprises providing at least two passpoint events during movement of the movable barrier during movement between the first position and the second position.

27. A movable barrier operator comprising:
a first passpoint sensor having an output that provides:
a first substantially consistent indicia when a movable barrier is positioned on one side of the first passpoint sensor;
a second substantially consistent indicia, which second substantially consistent indicia is different from the first substantially consistent indicia, when a movable barrier is positioned on an opposite side of the first passpoint sensor;
a movable barrier controller operably coupled to the first passpoint sensor.

28. The movable barrier operator of claim 27 wherein the first substantially consistent indicia comprises a first voltage level.

29. The movable barrier operator of claim 28 wherein the second substantially consistent indicia comprises a second voltage level, which second voltage level is different than the first voltage level, such that upon detecting the first voltage level the movable barrier controller can determine that the movable barrier is presently positioned on the one side of the first passpoint sensor and upon detecting the second voltage level the movable barrier controller can determine that the movable barrier is presently positioned on the opposite side of the first passpoint sensor.

30. The movable barrier operator of claim 27 and further comprising an event sensor that is operably coupled to the movable barrier controller.

31. The movable barrier operator of claim 30 wherein the movable barrier controller has at least a first mode of operation wherein the movable barrier is automatically caused to move in a particular direction as a function, at least in part, as to whether the movable barrier is on the one side of the first passpoint sensor or on the opposite side of the first passpoint sensor.

32. The movable barrier operator of claim 31 wherein the first mode of operation is responsive to the event sensor.

33. The movable barrier operator of claim 32 wherein the event sensor comprises a drive train disconnection sensor.

34. The movable barrier operator of claim 32 wherein the movable barrier controller further comprises direction control means responsive to the event sensor for selecting a particular direction of movement for the movable barrier based upon which side of the first passpoint sensor the movable barrier is presently positioned.

35. The movable barrier operator of claim 34 wherein the direction control means is further for selecting a particular direction of movement that causes the movable barrier to move towards the first passpoint sensor.

36. The movable barrier operator of claim 27 and further comprising
a second passpoint sensor that is operably coupled to the movable barrier controller and having an output that provides:
a third substantially consistent indicia when a movable barrier is positioned on one side of the second passpoint sensor;
a fourth substantially consistent indicia, which fourth substantially consistent indicia is different from the third substantially consistent indicia, when a movable barrier is positioned on an opposite side of the second passpoint sensor.

37. The movable barrier operator of claim 36 wherein the third substantially consistent indicia comprises a first voltage level.

38. The movable barrier operator of claim 37 wherein the fourth substantially consistent indicia comprises a second voltage level, which second voltage level is different than the first voltage level, such that the movable barrier controller can determine which side of the second passpoint sensor the movable barrier presently occupies.

39. The movable barrier operator of claim 36 and further comprising an event sensor that is operably coupled to the movable barrier controller.

40. The movable barrier operator of claim 39 wherein the movable barrier controller has at least a first mode of operation wherein the movable barrier is automatically caused to move in a particular direction as a function, at least in part, whether the movable barrier is on the one side of the first passpoint sensor, between the first passpoint sensor and the second passpoint sensor, or on the opposite side of the second passpoint sensor.

41. The movable barrier operator of claim 40 wherein the first mode of operation is responsive to the event sensor.

42. The movable barrier operator of claim 41 wherein the event sensor comprises a drive train disconnection sensor.

43. The movable barrier operator of claim 41 wherein the movable barrier controller further comprises direction control means responsive to the event sensor for selecting a particular direction of movement for the movable barrier based upon where the movable barrier is presently positioned with respect to both the first passpoint sensor and the second passpoint sensor.

44. A method comprising:
establishing a first zone as corresponds to a first range of travel of a movable barrier;
establishing a second zone as corresponds to a second range of travel of the movable barrier, which second zone is at least partially different than the first zone;
detecting when the movable barrier has a predetermined positional relationship with respect to either the first zone and the second zone to provide a detected zone;
upon detecting at least a first predetermined state with respect to a movable barrier operator, automatically selecting a particular direction of movement for the movable barrier as a function, at least in part, of the detected zone.

45. The method of claim 44 wherein the first zone and the second zone together comprise substantially all of a permitted travel distance of the movable barrier.

46. The method of claim 44 wherein detecting when the movable barrier has a predetermined positional relationship with respect to either the first zone and the second zone comprises monitoring for particular corresponding electric signals.

47. The method of claim 46 wherein monitoring for particular corresponding electric signals further comprises monitoring for a first voltage level as corresponds to the first zone and for a second voltage level as corresponds to the second zone.

48. The method of claim 44 wherein detecting at least a first predetermined state further comprises detecting disconnection of the movable barrier from the movable barrier operator.

49. The method of claim 44 wherein automatically selecting a particular direction of movement for the movable barrier as a function, at least in part, of the detected zone further comprises:
selecting a first direction of movement for the movable barrier when presently detecting the first zone; and
selecting a second direction of movement for the movable barrier, which second direction of movement is different from the first direction of movement, when presently detecting the second zone.

50. The method of claim 49 wherein:
selecting a first direction of movement further comprises selecting an opening direction of movement; and
selecting a second direction of movement further comprises selecting a closing direction of movement.

51. The method of claim 49 wherein:
selecting a first direction of movement further comprises selecting a direction of movement that is towards a passpoint; and
selecting a second direction of movement further comprises selecting a direction of movement that is towards the passpoint.

52. The method of claim 44 and further comprising:
establishing a third zone as corresponds to a third range of travel of the movable barrier, which third zone is at least partially different than both the first zone and the second zone;
and wherein detecting when the movable barrier has a predetermined positional relationship with respect to either the first zone and the second zone to provide a detected zone further comprises detecting when the movable barrier has a predetermined positional relationship with respect to any of the first zone, the second zone, and the third zone to provide the detected zone.

53. The method of claim 52 wherein the first zone corresponds to a range of travel that is proximal to a fully-opened position of the movable barrier.

54. The method of claim 53 wherein the third zone corresponds to a range of travel that is proximal to a fully-closed position of the movable barrier.

55. The method of claim 54 wherein automatically selecting a particular direction of movement for the movable barrier as a function, at least in part, of the detected zone further comprises:
selecting a first direction of movement for the movable barrier when the detected zone comprises the first zone; and
selecting a second direction of movement for the movable barrier, which second direction of movement is different from the first direction of movement, when the detected zone comprises the third zone.

56. The method of claim 55 wherein automatically selecting a particular direction of movement for the movable barrier as a function, at least in part, of the detected zone further comprises:
selecting a presently-selected direction of movement for the movable barrier when the detected zone comprises the second passpoint zone.

57. The method of claim 56 wherein selecting a presently-selected direction of movement further comprises selecting a direction of movement as was presently selected upon detecting the first predetermined state.
